(19) United States
(12) Patent Application Publication
(10) Pub. No.: US 2008/0250421 A1
(43) Pub. Date: Oct. 9, 2008

(54) Data Processing System And Method

(75) Inventors: Rohith Basavaraja, Bangalore Kamataka (IN); Palanisamy Periyasamy, San Jose, CA (US); Rahul Sahgal, Bangalore Kamataka (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett Packard Development Co, L.P., Houston, TX (US)

(21) Appl. No.: 12/052,686

(22) Filed: Mar. 20, 2008

(30) Foreign Application Priority Data
Mar. 23, 2007 (IN) 601/CHE/2007

(51) Int. Cl. G06F 9/46

(52) U.S. Cl. 718/105

(57) ABSTRACT

A method of forming a cluster from a plurality of potential clusters that share a common node, the method comprising determining a criticality factor of each potential cluster by combining criticality factors of the nodes of each potential cluster; and forming the cluster from the potential cluster with the highest criticality factor.

### RELATED APPLICATIONS

This patent application claims priority to Indian patent application serial no. 601/CHE/2007, having title “Data Processing System and Method”, filed in India on 23 Mar. 2007, commonly assigned herewith, and hereby incorporated by reference.

### BACKGROUND TO THE INVENTION

A computing cluster comprises a plurality of data processing systems, referred to as nodes in the following, that work together such that they appear to be a single data processing system. The three main types of computing cluster are high-availability, high-performance and load-balancing. A high-availability cluster includes redundancy such that if a node fails, the cluster can use the remaining nodes to provide the same features and services as before the failure. A load-balancing cluster includes a node that performs load balancing of workload between a plurality of nodes. A high-performance cluster provides increased performance by splitting a computational task across a plurality of nodes.

FIG. 1 shows an example of a high-availability cluster 100 comprising two nodes 102 and 104. The nodes can communicate with each other via a cluster interconnect 106. If the interconnect 106 fails, then the cluster must be reformed such that it comprises one of the two nodes 102 and 104. However, because the nodes cannot communicate, there is no way of resolving which node forms the cluster, or resolution is difficult.

FIG. 2 shows an example of a high-availability cluster 200 that includes two nodes 202 and 204 that can communicate via a cluster interconnect 206. The cluster 200 includes a shared disk that is a quorum disk 208. The node 202 and 204 can access the quorum disk since it is a shared disk. If the cluster interconnect 206 between the nodes 202 and 204 fails, then each node 202 and 204 attempts to claim the quorum disk 208 by writing to the quorum disk 208. The cluster is reformed by the node that claims the quorum disk 208 first. The node that does not claim the quorum disk 208 first does not become part of a cluster.

FIG. 3 shows an example of a high-availability cluster 300 that includes four nodes 302, 304, 306, and 308 that can communicate via cluster interconnects 310. The cluster interconnects 310 communicate via a cluster interconnect hub 311. The cluster 300 includes a quorum disk 312. The nodes 302, 304, 306 and 308 can communicate with the quorum disk 312 using storage system interconnects 314 that communicate via a storage interconnect hub 316. Let us assume a communication failure occurs in such a way that the nodes 302 and 304 can communicate with each other, but not with the nodes 306 and 308, and the nodes 306 and 308 can communicate to each other, but not with the nodes 302 and 304. In this scenario there are two sub-groups having equal number of nodes. One sub-group comprises the nodes 302 and 304 and the quorum disk 312, and another sub-group comprises the nodes 306 and 308 and the quorum disk 312. The cluster 300 must be reformed such that it comprises the highest number of nodes. Each node and the quorum disk is assigned a weight called a vote. The assignment can be static or dynamic. A node typically has a vote of either 1 or 0. Node votes are used to determine the sub-group which has the majority of votes, which may be, for example, the largest sub-group. The majority sub-group reforms the cluster, and the nodes not in the majority sub-group do not become part of the reformed cluster. If there is a tie (i.e. multiple sub-groups have an equal number of votes), the sub-group which claims the quorum disk first gets a majority of votes by including the quorum disk vote, and reforms the cluster.

A cluster may use votes to determine which cluster should be formed. Each node i in the cluster has a number of votes Vᵢ. The number of quorum votes QV is 1 where the cluster contains a quorum disk, and 0 where there is no quorum disk. CEV is the total number of votes in the cluster, where CEV=(VQ+V₁+V₂+ . . . +Vₙ), and n is the total number of nodes (not including the quorum disk) in the cluster. Q is the minimum number of votes that must be present in a cluster, where Q=(CEV+2)/2. Q is rounded down to an integer. If a cluster is formed with less than Q votes, there is a possibility that more than one sub-group can form the cluster which may cause data integrity problems. Therefore, for an N-node cluster each having 1 vote, Q=N/2+1.

It follows that a cluster can have up to N/2 nodes fail before it can no longer reform a cluster.

A cluster reforms when one or more nodes fail and/or communication failure among cluster nodes due to interconnect failure. To reform the cluster, each node determines which potential clusters it can form from the available nodes. Then, the node selects the potential cluster that has the highest number of votes. If there are multiple potential clusters with the same number of votes, then the potential cluster that claims the quorum disk (if any) is reformed as the cluster. The potential cluster which claims the quorum disk gets a majority of votes by including quorum disk vote.

### BRIEF DESCRIPTION OF THE DRAWINGS

Embodiments of the invention will now be described by way of example only, with reference to the accompanying drawings, in which:

FIG. 1 shows an example of a two-node cluster;

FIG. 2 shows an example of a two-node cluster including a quorum disk;

FIG. 3 shows an example of a four-node cluster including a quorum disk;

FIG. 4 shows an example of a two-node cluster according to an embodiment of the invention that includes a quorum disk;

FIG. 5 shows an example of a four-node cluster according to embodiments of the invention; and

FIG. 6 shows an example of a data processing system suitable for use with embodiments of the invention.

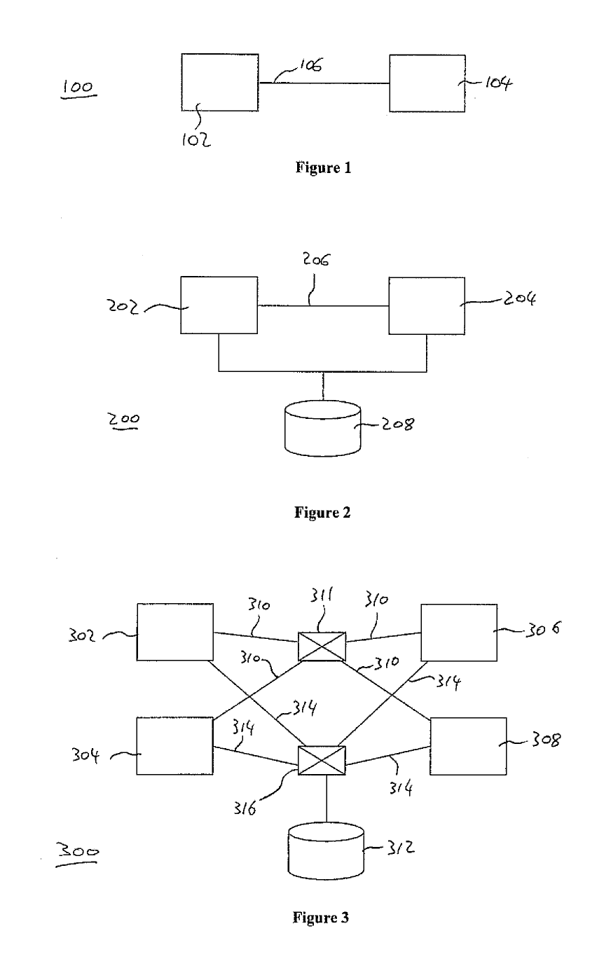

### DETAILED DESCRIPTION OF EMBODIMENTS OF THE INVENTION

Embodiments of the invention can be used to influence the reforming of a cluster such that it takes into account the criticality of one or more nodes. The criticality of a node is a factor assigned to the node to indicate its relative importance compared to other nodes. For example, where a node includes important hardware and/or is executing important applications, it can be assigned a higher criticality factor than other nodes, to indicate that it is relatively more important than other nodes. If the cluster is reformed without this node, the cluster may suffer compared to a reformed cluster that does contain this node. For example, the cluster may perform less efficiently and/or may have reduced functionality. In embodiments of the invention, the criticality factor assigned to a node is an integer. In embodiments of the invention, a higher integer indicates a higher criticality factor, although in other embodiments a lower integer may indicate a higher criticality factor. The criticality factor is used only when there is a tie using the voting mechanism. If there is also a tie using the criticality factor, then a potential cluster which claims the quorum disk first will reform the cluster.

For example, in a cluster with two data processing nodes, one node may provide internet banking whereas another node may provide backup facilities. The node that provides internet banking may have a higher criticality factor than the node that provides backup facilities if internet banking is considered to be more important than backup facilities. In another example, a first node in a cluster may comprise 16 data processors and 16 GB of main memory (RAM), whereas a second node in the cluster may comprise 2 data processors and 4 GB of RAM. The first node may be provided with a higher criticality factor than the second node to reflect that the first node may provide a higher performance than the second node. In embodiments of the invention, the criticality factor of a node may be set, for example, by a system administrator and/or cluster administrator. An interface may be provided on one or more nodes in a cluster to allow the criticality factor of one or more nodes in the cluster to be set.

Known high-availability clusters may be formed from a plurality of nodes that comprise, for example, Linux-HA operating system software or HP TruCluster Server for managing a high-availability cluster. Other operating systems and/or cluster management software may be used for high-availability clusters or other types of cluster.

The existing voting mechanism cannot be used to take the criticality of the nodes into account. It may not be practical to assign a higher number of votes to a node in a cluster to indicate that it has a higher importance. For example, in a cluster with two data processing system nodes and also a quorum disk node, such as the cluster 200 shown in FIG. 2, one data processing system node could have one vote whereas the other could have two votes. The quorum disk has one vote. Therefore, CEV for the node will be CEV=(2+1+1)=4, and Q=(4+2)/2=3. If the node with two votes fails, then the cluster cannot be reformed from the potential cluster comprising the remaining data processing node and the quorum disk, as the votes provided by the potential cluster total 2, which is less than the minimum Q=3. Therefore, no cluster would be reformed.

In embodiments of the invention, each node in a cluster has a criticality factor that is an integer, where a higher integer indicates a higher criticality factor. The quorum disk, if any, does not have a criticality factor, although the quorum disk may have a criticality factor in other embodiments of the invention.

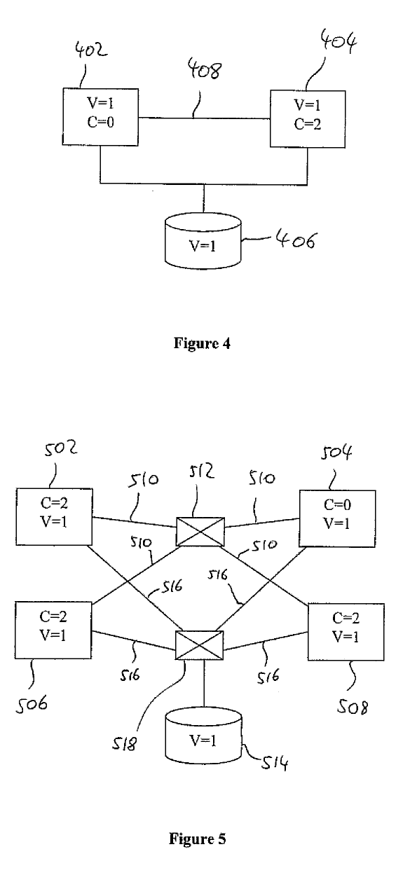

FIG. 4 shows an example of a cluster 400 that comprises two data processing system nodes 402 and 404 and a quorum disk 406. Each of the nodes 402 and 404 and the quorum disk 406 have one vote, indicated by V=1. The node 402 has a criticality factor of 0, whereas the node 404 has a criticality factor of 2. The nodes 402 and 404 can communicate via a cluster interconnect 408. The nodes 402 and 404 can access the quorum disk 406 since it is a shared disk.

If the interconnect 408 between the data processing system nodes 402 and 404 fails, then the cluster must be reformed. There are two potential clusters that could be reformed. These are the potential cluster comprising the node 402 and the quorum disk 406, and the potential cluster comprising the node 404 and the quorum disk 406. The quorum disk 406 is therefore a common node that is common to both potential clusters. In prior art methods, the reformed cluster would comprise the quorum disk 406 and the node 402 or 404 that first claimed the quorum disk 406.

The nodes 402 and 404 may notice that the interconnect 408 fails by, for example, receiving a notification from or relating to hardware associated with the interconnect 408, and/or determining that communication between the nodes 402 and 404 is not getting through. Software that manages certain clusters includes a “heartbeat” mechanism whereby each node sends a message to every other node in the cluster and waits for a response. If a response is not received from a node, then the interconnect between the nodes may have failed. Therefore, the node that did not receive the response knows that the cluster must be reformed.

In embodiments of the invention, the nodes 402 and 404 both attempt to claim the quorum disk 406 by writing to the quorum disk 406 since both of the sub-groups are just one vote short of majority (for the cluster 400, Q=2, so 2 votes are needed to reform the cluster). The node that first claims the forum disk examines the quorum disk 406, determines that no other node has yet written to the quorum disk, and then writes to the quorum disk 406 to reflect which node has written to the quorum disk and the criticality factor of the node. Other nodes subsequently attempt to write to the quorum disk 406 in the following manner.

A node examines the quorum disk 406 and determines that another node has claimed the forum disk 406 by writing to it. The node then examines the criticality factor stored on the quorum disk 406 and compares it with the node's own criticality factor. If the node's criticality factor is lower than or equal to that stored on the quorum disk 406, then the node has an equal or lower criticality factor than the node that claimed the quorum disk 406. The node therefore cannot claim the quorum disk 406 and does not form part of a cluster. If the node's criticality factor is higher than that stored on the quorum disk 406 then the node will claim the quorum disk 406, even though another node has already claimed it. The node will write to the quorum disk 406 to reflect that the node has claimed the quorum disk and store the criticality factor of the node, which is higher than the criticality factor previously stored on the quorum disk 406. The node that previously claimed the quorum disk 406 will leave the cluster.

The node that previously claimed the quorum disk 406 may, for example, monitor the quorum disk 406 at periodic intervals to determine whether it has been claimed by another node with a higher criticality factor.

For example, if the cluster interconnect 408 between the nodes 402 and 404 of the cluster 400 of FIG. 4 fails, the node 402 may claim the quorum disk 406 first by examining the quorum disk 406, determining that no other node has yet written to the quorum disk 406, and writing to the disk such that it indicates that the node 402 with a criticality factor of 0 has claimed the quorum disk. The cluster may then be reformed such that it comprises the node 402 and the quorum disk 406. Subsequently, the node 404 examines the quorum disk 406 and determines that it has been claimed by another node (node 402) with a lower criticality factor than the node 404. The node 404 will then claim the quorum disk 406 by writing to the disk such that it indicates that it has been claimed by the node 404 with a criticality factor of 2. The cluster will then be reformed such that it comprises the node 404 and the quorum disk 406. The node 402 will leave the cluster, for example by monitoring the quorum disk 406 and determining when it is claimed by another node with a higher criticality factor.

In contrast, if the cluster interconnect 408 fails, then the node 404 may claim the quorum disk 406 first by examining the quorum disk 406, determining that no other node has claimed the quorum disk, and writing to the quorum disk 406 such that it indicates that the node 404 with a criticality factor of 2 has claimed the quorum disk 406. The cluster will then be reformed such that it comprises the node 404 and the quorum disk 406. The node 404 will examine the quorum disk 406 and determine that it has been claimed by another node (node 404) with a higher criticality level. The node 404 cannot claim the quorum disk from a node with a higher criticality level than its own, and so the node 402 does not form part of the cluster.

In this way, either node 402 or 404 can claim the quorum disk 406 first, however the cluster that is ultimately formed comprises the nodes 404 and 406. Therefore, the criticality factor can be used to influence which potential cluster is reformed as the cluster, and can be used to ensure that the reformed cluster includes critical nodes, that is, for example, nodes that include important hardware and/or applications.

The criticality factor of each node may be stored within each node, or each node may store its own criticality factor. Additionally or alternatively, the criticality factor of each node may be stored on the quorum disk 406.

FIG. 5 shows an example of a cluster 500 that has four data processing system nodes 502, 504, 506 and 508. The cluster nodes 502, 504, 506 and 508 can communicate with each other via cluster interconnects 510 which communicate via a cluster interconnect hub 512. The nodes 502, 504, 506 and 508 can communicate with a quorum disk 514 via interconnects 516 that communicate via a storage interconnect hub 518. The nodes 502, 506 and 508 have a criticality factor of 2, whereas the node 504 has a criticality factor of 0. The nodes 502, 504, 506 and 508 and the quorum disk 514 each have one vote.

If there is communication failure between the nodes 504 and 506, then a new cluster must be formed from one of the two potential clusters. One potential cluster comprises the nodes 502, 508 and 504, and another potential cluster comprises the nodes 502, 508 and 506. The nodes 504 and 506 notice that they can't communicate with each other, but they can communicate with rest of the cluster members, for example, by receiving notification from or relating to the hardware associated with the interconnect 512, and/or by determining that communication between the nodes 504 and 506 is not getting through. Both of the nodes 504 and 506 send a proposal to the nodes 502 and 508 to reform the cluster. For example, the node 504 sends a proposal to the nodes 502 and 508 to reform the cluster such that it comprises the nodes 502, 508 and 504. Similarly, the node 506 sends a proposal to the node 502 to reform the cluster such that it comprises the nodes 502, 508 and 506. In prior art methods, whichever proposal is initiated first will be successful, and the node that sends the unsuccessful proposal will not become part of the reformed cluster.

In embodiments of the invention, one or both of the nodes 504 and 506 send a proposal to the nodes 502 and 508 as above. When the nodes 502 and 508 receive a proposal, they determine the potential clusters that can be formed and determine the combined criticality factors of the potential clusters. The combined criticality factor of a cluster comprises, for example, the total criticality factor of all of the nodes of the cluster. The nodes 502 and 508 then determine which potential cluster has the highest combined criticality factor. If this potential cluster is that proposed in the proposal received by the nodes 502 and 508, then the nodes 502 and 508 accept the proposal, and inform any nodes not in the reformed cluster that they will not be part of the reformed cluster. If the potential cluster with the highest criticality factor is not the one proposed in the proposal, then the nodes 502 and 508 reject the proposal. Instead, one of the nodes 502 and 508 will send proposals to the nodes in the potential cluster with the highest criticality factor to reform the cluster according to that potential cluster.

For example, in the cluster 500 of FIG. 5, if there is communication failure between the nodes 504 and 506, then the node 504 may send a proposal to the nodes 502 and 508 to reform the cluster such that it comprises the nodes 502, 508 and 504. When the nodes 502 and 508 receive this proposal, they determine that they can also reform the cluster such that it comprises the nodes 502, 508 and 506. The node 502 also determines that the combined criticality factor for the potential cluster comprising the nodes 502, 508 and 504 is 4, whereas the potential cluster comprising the nodes 502, 508 and 506 has a combined criticality factor of 6. Therefore, the node 502 and 508 rejects the proposal from the node 504, and one of the nodes (502 or 508) sends a proposal to the node 506 to reform the cluster such that it comprises the nodes 502, 508 and 506. The node 504 does not become part of the reformed cluster. The node 506 may or may not have sent a proposal to the node 502 before the node 506 receives a proposal from the node 502.

Alternatively, the node 506 may send a proposal to the nodes 502, 508 to reform the cluster such that it comprises the nodes 502, 508 and 506. When the nodes 502 and 508 receive this proposal, they determine that they can also reform the cluster such that it comprises the nodes 502, 508 and 504. The node 502 also determines that the combined criticality factor for the potential cluster comprising the nodes 502 and 504 is 4, whereas the potential cluster comprising the nodes 502 and 506 has a combined criticality factor of 6. Therefore, the nodes 502 and 508 accept the proposal from the node 506, and inform the node 504 that it is not part of the reformed cluster. The node 504 may or may not have sent a proposal to the nodes 502 and 508 before the node 504 receives the information from the node 502 or 508.

In this way, embodiments of the invention can be used to ensure that the cluster is reformed such that it comprises the potential cluster with the highest criticality factor.

The combined criticality factor can be applied to the embodiment comprising two data processing system nodes and a quorum disk, as shown in the cluster 400 in FIG. 4. The combined criticality factor for the cluster comprising the node 402 and quorum disk 406 is 0, as the criticality factor of the node 402 is 0, and the quorum disk 406 does not have a criticality factor. Similarly, the combined criticality factor of the cluster comprising the node 404 and the quorum disk 406 is 2. In other embodiments, the quorum disk may have a criticality factor associated with it.

In embodiments of the invention, cluster interconnects comprise any means for communicating between nodes. For example, a cluster interconnect may comprise cluster interconnect hardware such as, for example, HP-UX InfiniBand cluster interconnect solution. Cluster interconnects may comprise a plurality of interconnects and/or may include virtual interconnects where two nodes are, for example, located on a single data processing system.

In embodiments of the invention, the criticality factors of nodes can be used as a secondary consideration for the nodes that are part of the reformed cluster. For example, the votes provided by each potential cluster are counted, and the potential cluster with the highest number of votes is reformed as the cluster. In the event that there are multiple potential clusters with the same number of votes, then the combined criticality factor can be used as above to determine which potential cluster should become the reformed cluster.

Although embodiments of the invention have been describe with reference to high-availability clusters, embodiments of the invention may be applied to other types of cluster, such as, for example, high-performance clusters and/or load-balancing clusters.

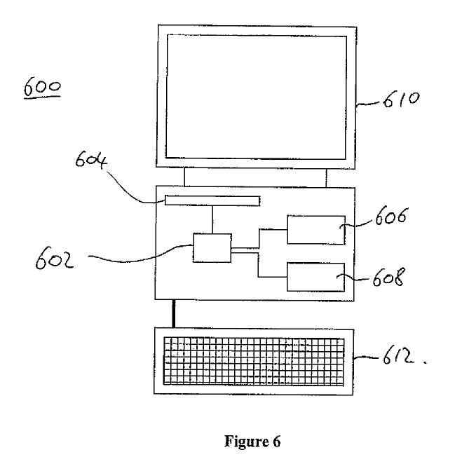

FIG. 6 shows a data processing system 600 suitable for use with embodiments of the invention. The data processing system 600 includes a data processor 602 and a memory 604. The system 600 may also include a permanent storage device 606, such as a hard disk, and/or a communications device 608. The communications device 608 may comprise, for example, cluster interconnect hardware for communicating with one or more nodes in a cluster via a cluster interconnect. The data processing system 600 may also include a display device 610 and/or an input device 612 such as a mouse and/or keyboard.

Embodiments of the invention reform a cluster from one of a plurality of potential clusters that share a common node. The common node may be, for example, a data processing system node and/or a quorum disk. The potential clusters may have more than one common node, or certain nodes may be common to some but not all potential clusters.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method of forming a cluster from a plurality of potential clusters that share a common node, the method comprising:
determining a criticality factor of each potential cluster by combining criticality factors of the nodes of each potential cluster; and
forming the cluster from the potential cluster with the highest criticality factor.

2. A method as claimed in claim 1, wherein the common node comprises a quorum disk.

3. A method as claimed in claim 1, wherein forming the cluster comprises:
at least one node in each potential cluster claiming the quorum disk; and
where the quorum disk has been claimed by a node in a potential cluster that has a lower criticality factor, surrendering the quorum disk to a potential cluster that has a higher criticality factor.

4. A method as claimed in claim 1, wherein combining the criticality factors of the nodes of a potential cluster comprises determining the total of the criticality factors.

5. A method as claimed in claim 1, wherein the potential clusters have the same number of votes.

6. A computer program for forming a cluster from a plurality of potential clusters that share a common node, the method comprising:
code for determining a criticality factor of each potential cluster by combining criticality factors of the nodes of each potential cluster; and
code for forming the cluster from the potential cluster with the highest criticality factor.

7. A computer program as claimed in claim 6, wherein the common node comprises a quorum disk.

8. A computer program as claimed in claim 6, wherein the code for forming the cluster comprises:
code such that at least one node in each potential cluster claims the quorum disk; and
code for surrendering the quorum disk to a potential cluster that has a higher criticality factor if the quorum disk has been claimed by a node in a potential cluster that has a lower criticality factor.

9. A computer program as claimed in claim 6, wherein the code for combining the criticality factors of the nodes of a potential cluster comprises code for determining the total of the criticality factors.

10. A computer program as claimed in claim 6, comprising code for determining the potential clusters that have the same number of votes.

11. A system for forming a cluster from a plurality of potential clusters that share a common node, the method comprising:
means for determining a criticality factor of each potential cluster by combining criticality factors of the nodes of each potential cluster; and
means for forming the cluster from the potential cluster with the highest criticality factor.

12. A system as claimed in claim 11, wherein the common node comprises a quorum disk.

13. A system as claimed in claim 11, wherein forming the cluster comprises:
means such that at least one node in each potential cluster claims the quorum disk; and
means for surrendering the quorum disk to a potential cluster that has a higher criticality factor if the quorum disk has been claimed by a node in a potential cluster that has a lower criticality factor.

14. A system as claimed in claim 11, wherein the means for combining the criticality factors of the nodes of a potential cluster comprises means for determining the total of the criticality factors.

15. A system as claimed in claim 11, comprising means for determining the potential clusters that have the same number of votes.

16. A system as claimed in claim 11, wherein the system is a node in a computing cluster.

17. Computer readable storage storing a computer program as claimed in claim 6.

18. A data processing system having loaded therein a computer program as claimed in claim 6.

19. A computing cluster comprising a plurality of nodes, wherein at least one of the nodes is arranged to carry out the method as claimed in claim 1.
